(19) United States
(12) Patent Application Publication
(10) Pub. No.: US 2013/0055114 A1
(43) Pub. Date: Feb. 28, 2013

(54) Enhanced and Extended Browsing Via Companion Mobile Device

(71) Applicant: Eitan Lev, Evan Yehuda (IL)

(72) Inventor: Eitan Lev, Evan Yehuda (IL)

(21) Appl. No.: 13/437,051

(22) Filed: Apr. 24, 2012

Related U.S. Application Data
(60) Provisional application No. 61/527,592, filed on Aug. 25, 2011.

(51) Int. Cl. G06F 3/01; G06F 15/16

(52) U.S. Cl. 715/760

(57) ABSTRACT

A method for using a mobile device as a companion device to a computer during a browsing session. In addition to browser code that provides content and control for the web page being browsed, mobile device code is downloaded to the computer, a direct connection between the computer and the mobile device is initiated, and the mobile device code is sent to the mobile device from the computer via the computer-mobile device connection. The mobile device code provides functionalities to the mobile device to extend and enhance the browsing session. The additional browser code and mobile device code is provided by the website's host server or by a separate service server.

### REFERENCE TO RELATED APPLICATION

The present application claims benefit of U.S. Provisional Patent Application Ser. No. 61/527,592, filed Aug. 25, 2011, entitled “Collaboration Between a Browser and Programmable Input Device”, the disclosure of which is hereby incorporated by reference and priority of which is hereby claimed pursuant to 37 CFR 1.78(a) (4) and (5)(i).

### FIELD

The present disclosure relates to interactive website browsing, and, more particularly, to a method for using a mobile device to support and enhance a browsing session on a computer.

### BACKGROUND

Internet browsing is conducted by users on computers of a variety of form factors and sizes. Browsing on a desktop or laptop computer benefits from the larger screen and keyboard, while browsing on a mobile device offers mobility, portability and additional sensors such as camera, GPS receiver, and accelerometers.

Unfortunately, interactive collaboration between larger computers and smaller mobile devices is currently restricted to either general-purpose use (that is, session-independent), or to a specific program running on the computer (for example, a game or presentation program). There is thus a need for methods by which a handheld mobile device can better cooperate with a computer during browsing, to support and enhance the user's browsing experience. This goal is met as described in the present disclosure.

### SUMMARY

The present disclosure provides methods for a network server to enable a mobile device to act as a companion device for a computer in a browsing session between the computer and a host server.

For most browsing, a computer is typically preferred over a mobile device because the computer has a larger screen and can thus display more of the current webpage than the mobile device. The mobile device, however, has properties and capabilities which the typical computer lacks, and which can be used to extend and enhance the browsing experience. The present disclosure teaches systems and methods for using a mobile device as a companion to the computer when browsing, to benefit from the integration of and synergy between the properties and capabilities of both a computer and a mobile device.

### DEFINITIONS

The terms “browser program” and “browser” herein denote a software program which retrieves web content from a remote server via the Internet and presents the content to a user. These terms denote programs dedicated to retrieving web content from one or more predetermined servers, as well as programs configured for general-purpose use to retrieve web content from servers according to arbitrary user requests and preferences. The process of using a browser to access web content is referred to as “browsing”, and the context in which the user performs the browsing with the browser is referred to as a “browsing session”.

The term “add-on” (also known as an “add-in”, a “plug-in”, or a “browser app”) herein denotes a software module which adds one or more functionalities to a browser. When installed in, or associated with a browser, an add-on and the capabilities thereof are herein considered to be integral components of the browser, as if the browser were originally programmed to have those capabilities.

The term “web page” herein denotes presentable content available over the World-Wide Web, and accessible via a particular Uniform Resource Locator (URL).

Web pages typically include interactive functionalities, whereby the user can control the browsing session as well as the substance and presentation of the web content of the browsing session.

The term “current page” herein denotes a specific web page.

The term “website” herein denotes a collection of one or more web pages hosted on a server and containing material for user consumption, and available for user access via the Internet using a computer and a browser.

The term “web content” herein includes any material for user consumption that is presented to the user via a website.

For browsing, a user requests access to a particular website according to the website's network address or a representation thereof. Typically, but not exclusively, the address is in the form of a URL, which is automatically converted by network Domain Name Servers into an Internet Protocol (IP) address suitable for use on the network. When the browser presents web pages, the user may navigate through the web pages, and may click on links to other web pages or other websites.

The term “computer” herein denotes a device usable by a user and including a processor, a browser, and a communication capability for connecting to the Internet, non-limiting examples of which include a personal computer, notebook computer, tablet computer, smartphone and a smart TV.

The term “gesture” herein denotes a predefined movement or sequence of movements involving the human body or accessories thereto, such as handheld objects or objects attached to the body. In particular, gestures involving a stylus or one or more fingers are commonly used to indicate commands on the surface of a touch pad or touch screen.

The term “mouse” herein broadly denotes any user pointing device and any accessory controls and interpreting mechanisms thereof, non-limiting examples of which include: mouse; trackball; joystick; touchpad; touch screen; touch gesture interpreter; accelerometer; orientation sensor; and the like.

The term “mouse cursor” herein denotes an artifact displayed on the screen at a screen position selected by the mouse. Not all pointing devices display a mouse cursor, however. In particular, touch-screens used as pointing devices typically lack mouse cursors, because the selected position is wherever the touch screen is touched by a finger or stylus.

The term “click” (also as in “left-click”, “right-click”, “double-click”, and the like) herein denotes the selection of a point or feature at a web page screen position indicated by a mouse, such as by: pressing a button of the mouse; tapping a surface of a touch pad or touch screen; performing a gesture on the surface of a touch pad or touch screen; a gesture captured by a video gesture interpreter; or a predefined acceleration or change in orientation of a pointing device. Most interactive features of a web page require user selection via a click to command the browsing session. However, some interactive features respond to proximity of a mouse cursor even in the absence of a click. For example: a “mouse over” a pre-designated area of the screen can trigger an interactive feature without requiring a click; and certain gestures on a touch screen may trigger an interactive feature by proximity of the stylus or finger(s) without requiring a tap.

Web pages typically have features which can receive user input, non-limiting example of which include interactive controls such as text entry fields, buttons, mouse-clickable and tappable regions, selectable lists and drop-down boxes, and so forth.

The term “executable code” (or “executable command”) with respect to presentation of web content includes any form of code or commands which are executed or interpreted by a program, script, or processor on a computer presenting or formatting a web page or portion thereof, wherein the executable commands include processor-executable instructions. Non-limiting examples of “executable code” include commands for displaying screen controls (buttons, form-fields, text boxes, lists, and the like), formatting commands (such as for text and graphical layout), style sheets, interpretable instructions for an interpreter program, scripts, applications (also known as “applets” and “apps”), HTML code, Java scripts, and ActiveX code.

The term “browser code” herein denotes any data for a data stream from a host server to a browser for presenting any part of a web page, including both executable code as well as embedded data, non-limiting examples of which include text, graphics, animations, audio/video material, downloadable files, and links (or “references”) to other material available to the user over the network.

Therefore, there is herein disclosed a method for coordinating a mobile device with a computer running a browser program during a website browsing session of a website, wherein the mobile device is separate from the computer, the method including: (a) sending to the computer, by a first server, during the browsing session, browser code for presenting the website on the computer; and (b) sending to the mobile device, by a second server, during the browsing session, mobile device code associated with the website, for implementing a functionality of the mobile device related to the browsing session.

In addition, there is herein disclosed a method implemented by a server for coordinating a mobile device with a computer running a browser program during a browsing session of a website, wherein the mobile device is separate from the computer, the method including: (a) associating the mobile device with the computer; and (b) sending to the mobile device, by the server, during the browsing session, mobile device code associated with the website, for implementing a functionality of the mobile device related to the browsing session.

### BRIEF DESCRIPTION OF THE DRAWINGS

The present disclosure includes drawings in which:

FIG. 1A illustrates a prior-art web browsing session between a website host server and a computer browser.

FIG. 1B illustrates a prior art web page contents for the browsing session shown in FIG. 1A.

FIG. 2A illustrates a web browsing session between a website host server and a computer browser with a companion mobile device, as presently disclosed.

FIG. 2B illustrates a web page contents for the browsing session shown in FIG. 2A, as presently disclosed.

FIG. 3A illustrates a web browsing session between a website host server and a computer browser with a companion mobile device and a website service server, as presently disclosed.

FIG. 3B illustrates a service page contents for the browsing session shown in FIG. 3A, as presently disclosed.

FIG. 4A illustrates a method as presently disclosed.

FIG. 4B illustrates a method as presently disclosed.

FIG. 5 illustrates operation of a mobile device code database as presently disclosed.

### DETAILED DESCRIPTION

The principles and operation of a method according to the present disclosure may be understood with reference to the drawings and the accompanying description.

### Mobile Device as a Companion to a Browser

Important properties of a mobile device include its small size and portability. A mobile device can be easily carried to locations where it would be inconvenient or impractical to carry a computer. Additionally, using a mobile device may provide expanded capabilities because the mobile device may contain hardware sensors and other components that may not be found on a computer, including, but not limited to:
Camera (still pictures and video);
Microphone;
GPS receiver;
Compass;
Accelerometer(s) (also for sensing up/down orientation); and
Telephone connection (voice and text).

In addition to hardware components that may not be found on a computer, a mobile device may have installed apps to perform specialized actions or services for which there may not be a readily-available counterpart on the computer.

In a non-limiting example of a mobile device as a companion to a browsing session, a user accesses an auction website which allows users to list items they wish to put up for sale. In conjunction with listing an item, the website offers the user the option of uploading a photograph of the item for presentation on the website to prospective bidders. Currently, this requires that the user obtain or take a photograph of the item (e.g., an antique or other collectible object, an automobile, a piece of real estate, etc.), convert the photograph to digital format if necessary, put the digitized photograph into a file on the computer, and upload the digital photograph file via the browser. This procedure involves considerable manual intervention by the user. Under the present disclosure, however, the user's mobile device (e.g., a mobile telephone) is available as a companion to the browsing session, the process taking advantage of the mobile device's portability and built-in camera to greatly simplify the process for the user. In such a scenario, the relevant web page preferably presents an option to the user to upload photo via mobile. This would be displayed by the browser on the computer, and the user would select the option by clicking on it. Then, a notification would appear on the mobile device, requesting that the user employ the camera in the mobile device to photograph the desired object. Upon confirmation by the user, the mobile device would then take the picture and automatically upload the photograph to the website without any further action on the user's part.

In another non-limiting example of a mobile device as a companion to a browsing session, a user accesses a sightseeing website which allows users to input geographical locations, geographical routing information, or street directions. Currently, this would require that the user manually locate map positions, or obtain global coordinates with a GPS receiver and manually enter them into the website. Under the present disclosure, however, the user's mobile device is programmed as a companion to the browsing session, so that the process takes advantage of the mobile device's portability and built-in GPS receiver to simplify the process. In a manner analogous to that presented above, the user is preferably prompted via a notification to take the mobile device to the desired locations and/or along the desired route and obtain the corresponding coordinates, which the mobile device then automatically uploads to the website.

In yet another non-limiting example of a mobile device as a companion to a browsing session, a user accesses a grocery shopping website which allows users to enter a shopping list of food products and household items. Currently, this requires that the user manually enter items from lists into the website. If, however, the user's mobile device is available, according to the present disclosure, as a companion to the browsing session, the process preferably takes advantage of the mobile device's portability and a built-in barcode/QR code scanner app to simplify the process. In a manner analogous to that presented above, the user would be prompted via a notification to take the mobile device around the house and scan the printed codes from needed products, which the mobile device would then automatically upload to the website.

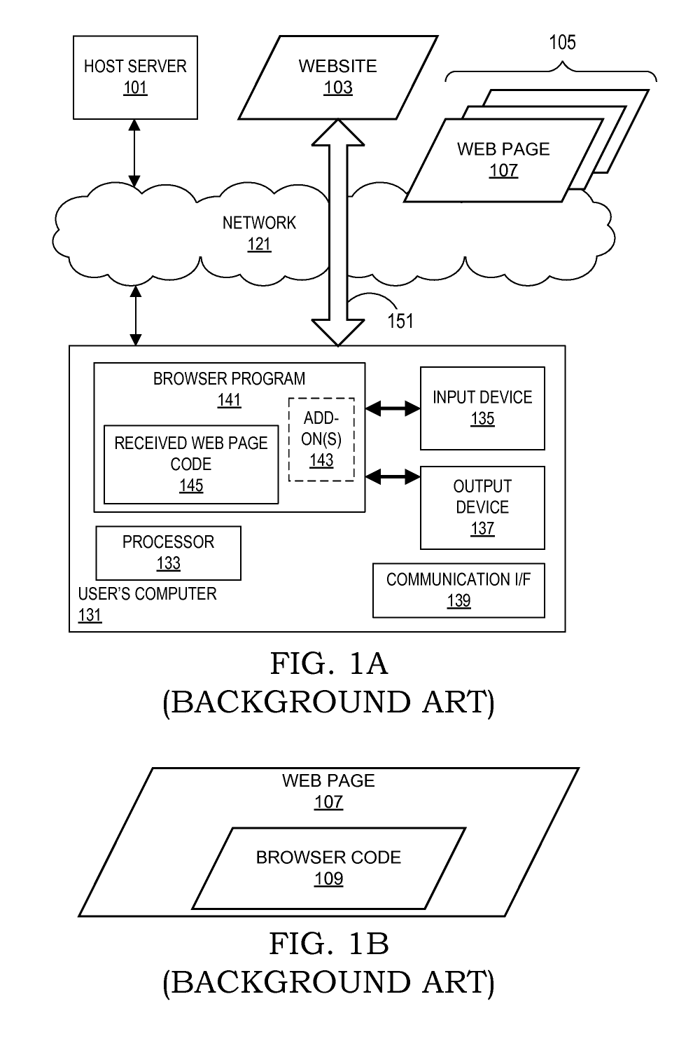

In a similar manner, other properties and capabilities of the mobile device could be utilized to expand and enhance the browsing session. FIG. 1A illustrates a background art browsing session 151 between a website 103 and a user's computer 131 running a browser program 141 (referred to as a “browser” for brevity). Browser 141 presents a web page 107 during browsing session 151. When a computing device browses web page 107, the host server provides code to browser 141 for presenting web page 107 to the user. Browser 141 interacts with the user and sends user commands related to web page 107 of website 103 back to host server 101. The web page code is stored locally in computer 131 as received web page code 145 for access by browser 141.

Website 103 includes one or more web pages 105 which the user (not shown) is able to browse. Browsing session 151 is implemented by a host server 101 via a network 121 to browser 141 running in user's computer 131 via a communications interface 139. In the context of website browsing, the term “host” server is commonly used to refer to the server that furnishes the website content over the network to client computers that are browsing the website. That is, the common host server for a website is a web content server. Browsing session 151 extends over a time period during which the user browses one or more of web pages 105. Browser program 141 is executed by a processor 133 and communicates with one or more input and output devices, such as an input device 135, an output device 137, and a communications interface 139. Browser 141 has access to a received web page code 145 and may be supplemented by one or more optional installed add-on functionalities, such as an add-on 143.

FIG. 1B illustrates a background art web page 107 contents for browsing session 151 as described above and shown in FIG. 1A, showing that web page 107 essentially consists solely of browser code 109.

In some cases, the interactive features presented during the browsing session originate locally from the browser, non-limiting examples of which are the browser's scrolling controls, menu formatting selections, and the like. These local features are typically handled by the browser (or its add-ons) and involve the browser's manipulation of already-received web code. In such cases, the user's interactive input does not cause a change in the received web code, but rather only causes changes in the way the browser presents the received web code.

In other cases, the interactive features presented during the browsing session originate in a website (via a host server of the website). In such cases, the user's interactive input can cause a change in the received web code. In a non-limiting example, a geographical map website sends web code to the browser to present a map of a geographical region, which has interactive features that respond to user mouse commands. If the user commands the browser to scroll or to zoom the map, the browser requests the website host server to resend the code for displaying the map using the new map location and scale according to the user's command. In such cases, the user's interactive input causes a change in the received web code.

Regardless of how and where the user's interactive commands are interpreted and carried out, however, it appears to the users as if they are controlling the browsing session with their commands.

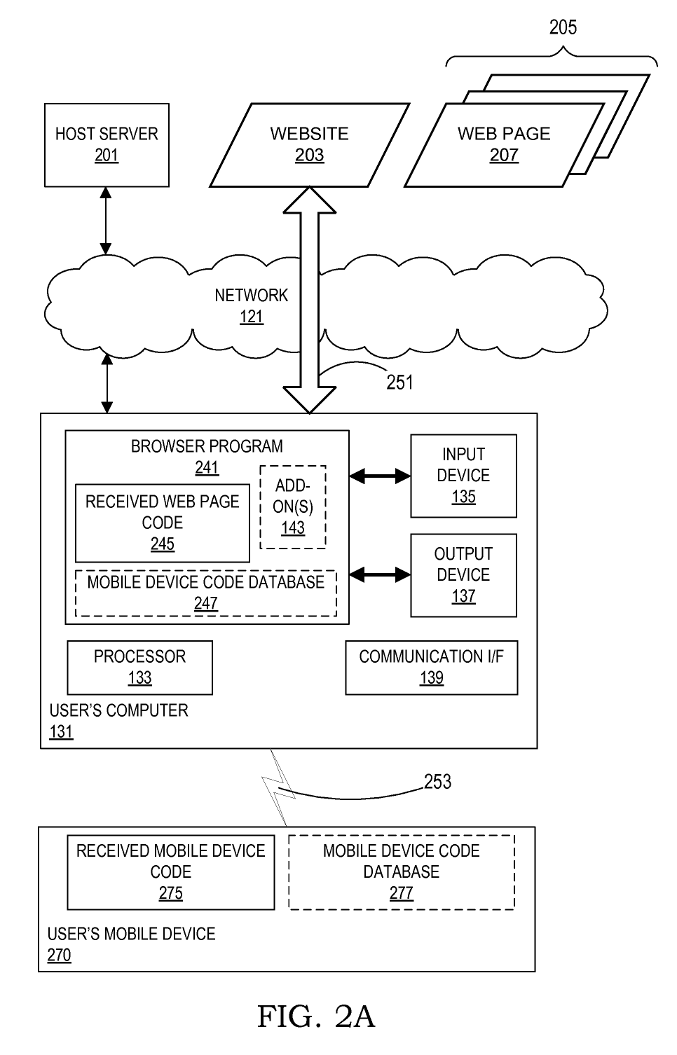

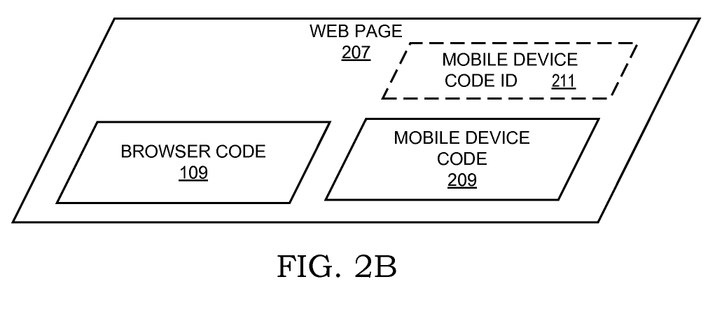

FIG. 2A illustrates a browsing session 251 between a website 203 and user's computer 131 running browser program 241 according to an example as presently disclosed. Website 203 includes one or more web pages 205, such as a web page 207. Browsing session 251 is implemented by a host server 201 via network 121 to browser 241 running in user's computer 131. Browsing session 251 extends over a time period during which the user browses one or more of web pages 205. Browser program 241 is executed by processor 133 and communicates with one or more input and output devices, such as input device 135 and output device 137. Browser 241 has access to a received web page code 245 and may be supplemented by one or more optional installed add-on functionalities, such as an add-on 143. In certain embodiments disclosed herein, browser program 241 contains a mobile device code database 247. In other embodiments, browser program 241 lacks mobile device code database 247.

In embodiments in the present disclosure, mobile device code 275 contains instructions, which, when processed by the mobile device, cause the mobile device to take an action, including, but not limited to the following:
sending information to the user via an output in the mobile device;
receiving information from the user, via a user input in the mobile device;
acquiring data from a sensor of the mobile device;
sending a report from the mobile device to the computer about the browsing session;
receiving instructions by the mobile device from the computer concerning the browsing session;
sending a communication from the mobile device to the computer;
sending data from the mobile device to the computer;
receiving data by the mobile device from the computer;
controlling a browsing session on the computer according to user input from a user interface of the mobile device; and
configuring a hardware component of the mobile device.

A mobile device 270 has a bidirectional connection 253 with browser 241, by which browser 241 and mobile device 270 communicate directly, rather than indirectly, such as via a website, or by an intermediate server on a network. Direct connection 253 between browser 241 and mobile device 270 of embodiments disclosed herein provides a fast and reliable data path between browser 241 and mobile device 270. Mobile device 270 contains received mobile device code 275. In some examples, mobile device 270 contains a mobile device code database 277. In other examples, mobile device 270 lacks mobile device code database 277.

User computer 131 and mobile device 270 are separate devices. The term “separate” herein denotes that the devices are physically and logically different devices, which can be used independently of one another at the same time.

FIG. 2B illustrates web page 207 contents according to examples of browsing session 253, showing that web page 207 comprises both browser code 109 and mobile device code 209. In some examples utilizing batch mode transfers (see below), a mobile device code ID 211 is also used as a database key to identify mobile device code 209.

Taking both FIG. 2A and FIG. 2B together, in certain disclosed examples, website 203 (provided by host server 201) not only provides browser code 109 to browser 241, but also provides mobile device code 209 to mobile device 270 via connection 253. In this manner, website 203 not only provides the web content for browser 241 to present to the user, but also provides functionalities (as previously exemplified) for mobile device 270 to expand and enhance the browsing session.

In certain examples, website 203 provides mobile device code 209 to mobile device 270 on an inline transfer basis. That is, mobile device code 209 is sent from website 203 to mobile device 270 as needed. In other examples, mobile device code 209 is sent by website 203 in batch mode transfer. That is, mobile device code 209 is sent in bulk by website 203 to be stored locally and to be available and used when needed. In one embodiment mobile device code 209 is stored locally in mobile device code database 247 within browser 241. In another embodiment mobile device code 209 is stored locally in mobile device code database 277 within mobile device 270. As noted above, for batch mode transfer, a mobile device code ID 211 is utilized to identify mobile device code 209.

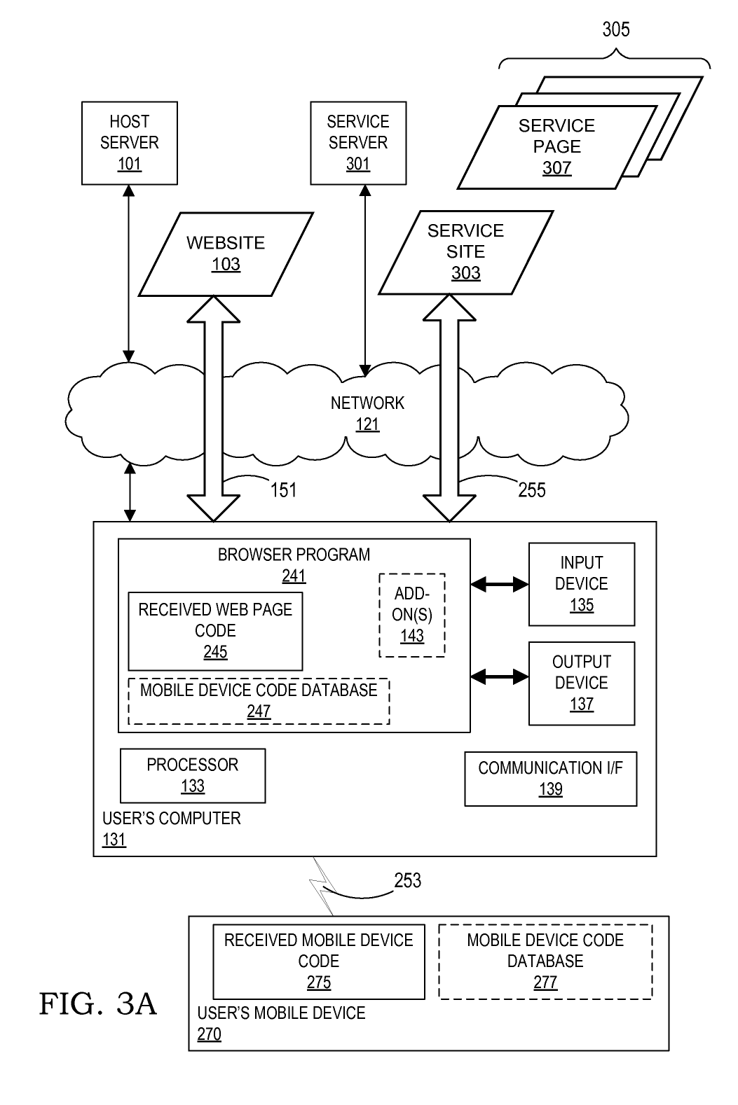

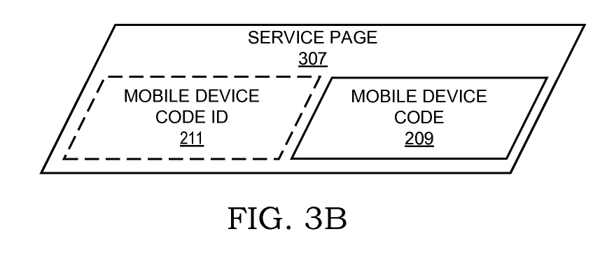

FIG. 3A illustrates a browsing session 151 between a website 103 and browser 241, as supplemented by a session 255 with a service site 303, which is implemented by a service server 301, according to an example described herein. In this embodiment, it is service server 301 which provides mobile device code 209 via service site 303, rather than host server 101. This can also be seen in FIG. 3B, illustrating a service page 307, which includes mobile device code 209. In another embodiment, service page 307 contains mobile device code ID 211, as discussed above.

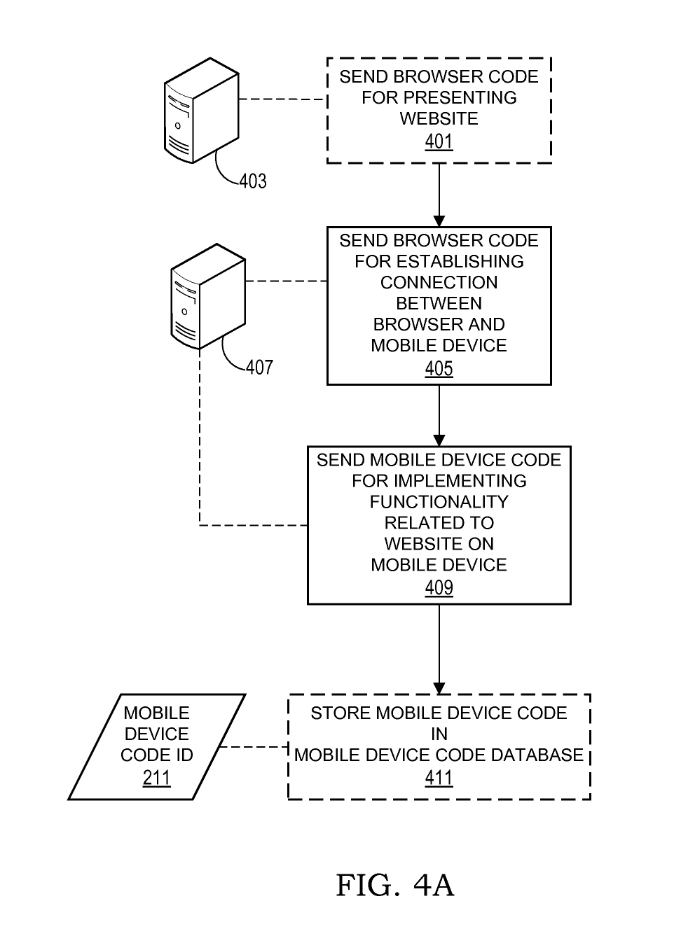

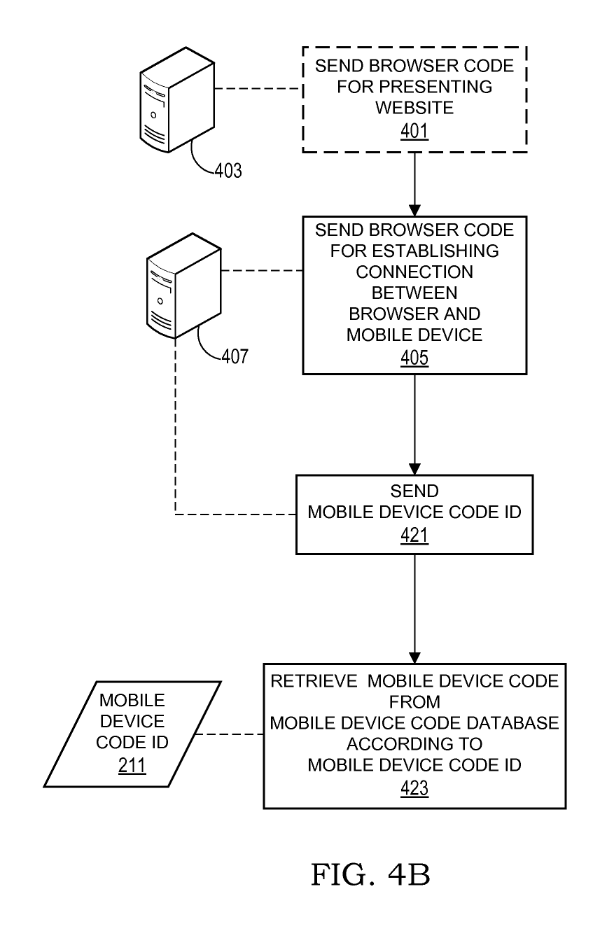

FIG. 4A illustrates a method according to certain examples described herein. In a step 401, a first server 403 sends browser code to a browser (not shown) for presenting a website (not shown). In a step 405, a second server 407 sends browser code to the browser for establishing a connection between the browser and a mobile device (not shown). In a step 409, second server 407 sends mobile device code suited for implementing a functionality related to the website, including one or more specific pages of the website. In one embodiment, first server 403 and second server 407 are physically and logically the same server, a host server. In another embodiment, first server 403 is a host server, and second server 407 is a service server. In still another example host server 403 is independent of service server 407, and step 401 is therefore performed independently.

In a further example, the method includes a step 411, wherein mobile device code is stored in a mobile device code database according to mobile device code ID 211. Step 411 can performed before, during, or after step 409. In one embodiment, mobile device code database 247 (FIG. 2A) is used. In another embodiment, mobile device code database 247 (FIG. 2A) is used.

FIG. 4B illustrates another example, where, in a step 423 mobile device code is retrieved from a mobile device code database according to mobile device code ID 211. As with FIG. 4A, in one example mobile device code database 247 (FIG. 2A) is used, and in another example mobile device code database 277 (FIG. 2A) is used.

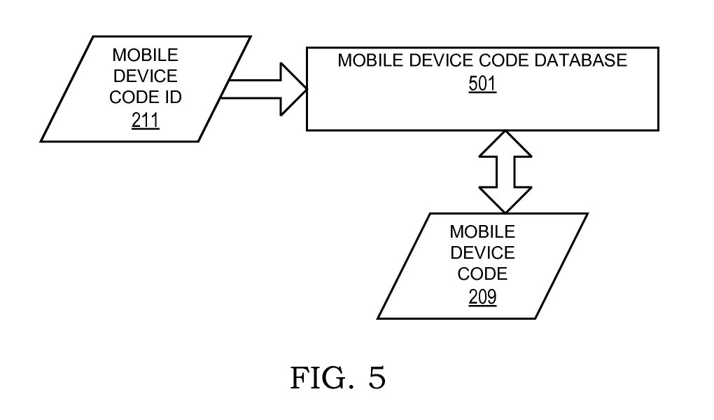

FIG. 5 illustrates an example described in the present disclosure, where a mobile device code ID 211 serves as a key for a mobile device code database 501 to store and retrieve mobile device code 209.

A further example provides a server product for performing, on a server, methods disclosed herein, or variants thereof.

A server product for a method according to this embodiment includes a set of executable commands for performing the method on a server, wherein the executable commands are contained within a tangible non-transient data storage medium including, but not limited to: media such as magnetic media and optical media; memory; semiconductor memory storage; flash memory storage; data storage devices and hardware components; and the tangible non-transient storage devices of a remote device or communications network; such that when the executable commands of the server product are executed by the server, the server product causes the server to perform the method.

While the present disclosure describes a limited number of examples, it will be appreciated that many variations, modifications and other applications may be made.

What is claimed is:

1. A method for coordinating a mobile device with a computer running a browser program, during a website browsing session of a website, wherein the mobile device is separate from the computer, the method comprising:
sending to the computer, by a first server, during the browsing session, browser code for presenting the website on the computer; and
sending to the mobile device, by a second server, during the browsing session, mobile device code associated with the website, for implementing a functionality of the mobile device related to the browsing session.

2. The method of claim 1, further comprising:
sending a mobile device code identifier with the mobile device code; and
storing the mobile device code in a mobile device code database according to the mobile device code identifier.

3. The method of claim 2, wherein the mobile device code database is stored in the computer.

4. The method of claim 2, wherein the mobile device code database is stored in the mobile device.

5. The method of claim 2, further comprising:
sending a mobile device code identifier; and
retrieving mobile device code from the mobile device code database according to the mobile device code identifier.

6. The method of claim 1 further comprising:
sending, by the first server during the browsing session, browser code to the computer for establishing a data connection between the computer and the mobile device;
wherein the sending to the mobile device, by the second server, is via the data connection between the computer and the mobile device.

7. The method of claim 6, wherein the first server is a host server of the website, and the second server is also the host server of the website.

8. The method of claim 6, wherein the first server is a host server of the website, and the second server is a service server which is physically and logically distinct from the host server of the website.

9. The method of claim 1, wherein the mobile device code contains processor-executable instructions for sending content from the mobile device to the computer for uploading to the host server.

10. The method of claim 1, wherein the mobile device code and the functionality are both specific to a current page of the website.

11. The method of claim 1, wherein the mobile device code and the functionality are suited to more than one page of the website.

12. The method of claim 1, wherein the browser code includes HTML code.

13. The method of claim 1, wherein the mobile device code is operative to configure a hardware component of the mobile device.

14. The method of claim 1, wherein the mobile device code includes code for receiving a user input in the mobile device that relates to a feature on a page of the website.

15. The method of claim 1, wherein the mobile device code includes code for presenting on the mobile device a user notification related to a page of the website.

16. The method of claim 15, wherein the mobile device code includes code for receiving a user input in the mobile device in response to the notification.

17. The method of claim 1, wherein the mobile device code includes code for controlling the browsing session from a user interface of the mobile device.

18. The method of claim 17, further comprising receiving, by the host server, a command from the mobile device to control the browsing session.

19. The method of claim 18, further comprising: sending to the computer, by the host server, browser code in response to the command from the mobile device.

20. The method of claim 1, further comprising receiving from the mobile device, by the host server, a communication related to the browsing session.

21. A method implemented by a server for coordinating a mobile device with a computer running a browser program during a browsing session of a website, wherein the mobile device is separate from the computer, the method comprising:
associating the mobile device with the computer; and
sending to the mobile device, by the server, during the browsing session, mobile device code associated with the website, for implementing a functionality of the mobile device related to the browsing session.

22. The method of claim 21, wherein the server is the host server of the website.

23. The method of claim 21, wherein the server is a service server that is separate from the host server of the website.

24. The method of claim 21, wherein the association is implemented by:
sending a mobile device code identifier with the mobile device code; and
storing the mobile device code in a mobile device code database according to the mobile device code identifier.

25. The method of claim 24, wherein the mobile device code database is stored in the computer.

26. The method of claim 24, wherein the mobile device code database is stored in the mobile device.

27. The method of claim 21, wherein the associating is implemented by:
sending a mobile device code identifier; and
retrieving mobile device code from the mobile device code database according to the mobile device code identifier.

28. The method of claim 21, wherein the mobile device code is operative to configure a hardware component of the mobile device.

29. The method of claim 21, wherein the mobile device code includes code for receiving a user input in the mobile device that relates to a feature on the web page.

30. The method of claim 21, wherein the mobile device code includes code for presenting on the mobile device a user notification related to a page of the website.

31. The method of claim 30, wherein the mobile device code includes code for receiving a user input in the mobile device in response to the notification.

32. The method of claim 21, wherein the mobile device code includes code for controlling the browsing session from a user interface of the mobile device.

33. The method of claim 21, further comprising receiving, by the service server, from the mobile device via the data connection between the computer and the mobile device, a communication related to the browsing session.

34. The method of claim 33, wherein the communication includes a command from the mobile device to control the browsing session.

35. The method of claim 34, further comprising:
sending to the computer, by the service server, browser code in response to the command from the mobile device.

36. A server for coordinating a mobile device with a computer running a browser program during a browsing session of a website, wherein the mobile device is separate from the computer, wherein the server is operative to:
associate the mobile device with the computer; and
send to the mobile device, during the browsing session, mobile device code associated with the website, for implementing a functionality of the mobile device related to the browsing session.

37. A server product for a server, to coordinate a mobile device with a computer running a browser program during a browsing session of a website, wherein the mobile device is separate from the computer, wherein the server product comprises a tangible non-transient data storage medium which contains executable instructions, such that when the executable instructions are executed by the server, the server product causes the server to perform the method of claim 21.

38. A method for coordinating a mobile device with a computer running a browser program, during a website browsing session of a website by the computer, wherein the mobile device is separate from the computer, the method comprising:
receiving, during the browsing session, by the mobile device from a server, mobile device code associated with the website, and
executing, during the browsing session, by the mobile device, the mobile device code, for implementing a functionality of the mobile device related to the browsing session.
